(19) United States
(12) Patent Application Publication
(10) Pub. No.: US 2018/0341491 A1
(43) Pub. Date: Nov. 29, 2018

(54) APPARATUS AND METHOD FOR MEMORY SHARING BETWEEN COMPUTERS

(71) Applicant: ELECTRONICS AND TELECOMMUNICATIONS RESEARCH INSTITUTE, Daejeon (KR)

(72) Inventors: Yong-Seok CHOI, Daejeon (KR); Shin-Young AHN, Daejeon (KR); Eun-Ji LIM, Daejeon (KR); Young-Choon WOO, Daejeon (KR); Wan CHOI, Daejeon (KR)

(21) Appl. No.: 15/973,962

(22) Filed: May 8, 2018

(30) Foreign Application Priority Data
May 25, 2017 (KR) 10-2017-0064725

(51) Int. Cl. G06F 9/32; G06F 13/16; G06F 13/42; G06F 13/40; G06F 9/38

(52) U.S. Cl. CPC G06F 9/322; G06F 13/1668; G06F 9/3851; G06F 13/4022; G06F 13/4282

(57) ABSTRACT

Disclosed herein are an apparatus and method for sharing memory between computers. The apparatus for sharing memory between computers includes multiple memory adapters, installed in corresponding ones of multiple computers, for receiving an address corresponding to an instruction from the computers and transforming the received address into an instruction in the form of a packet; and shared memory for transforming the instruction in the form of the packet, received from the multiple memory adapters, into an address and performing an operation corresponding to the instruction for a memory cell corresponding to the address.

### CROSS REFERENCE TO RELATED APPLICATION

This application claims the benefit of Korean Patent Application No. 10-2017-0064725, filed May 25, 2017, which is hereby incorporated by reference in its entirety into this application.

### BACKGROUND OF THE INVENTION

### 1. Technical Field

The present invention relates generally to technology for sharing memory between computers, and more particularly to technology for sharing memory between computers through which all computers may access the same memory space.

### 2. Description of the Related Art

A computer includes one or more Central Processing Units (CPUs), memory, and an input/output (I/O) slot. The memory of a first computer is used exclusively by the first computer. When the first computer attempts to read from the memory of a second computer or to write data thereto, the first computer uses a network interface card installed in an I/O slot thereof.

Here, the first computer transmits an instruction to the network interface card thereof, and the network interface card transmits the instruction to the network interface card connected to the I/O slot of the second computer via a network switch. The CPU of the second computer may receive the instruction through the I/O slot thereof and allow access to the memory thereof.

Generally, a computer has limits on the amount of memory that it can support. Accordingly, data commonly used by all computers connected via a network switch are stored in the respective computers in a distributed manner.

When N computers share data therebetween, data stored in the memory of the respective computers in a distributed manner may be accessed through N*N memory accesses. That is, with an increase in the number of computers, the required number of memory accesses increases exponentially.

Meanwhile, after a computer having a large amount of memory is selected, the computer may be implemented to be used only for the purpose of storing shared data. For example, when the memory of the second computer is used only for the purpose of storing shared data, because all computers must access the second computer through the network interface card of the second computer via a network switch, parallel processing is impossible due to the characteristics of network packet communication.

That is, because accesses to the memory of the second computer are sequentially processed, the network load required to be processed by the network interface card of the second computer increases. Also, because such memory accesses are processed only by the CPU of the second computer, a bottleneck may be formed. Further, because the network interface card and the CPU of the second computer must process a complicated network stack, data are frequently copied therebetween, which may cause unnecessary power consumption and the waste of resources.

Therefore, it is necessary to develop technology for sharing memory between computers that may solve problems in which the number of memory accesses increases exponentially when shared data are stored in the memory of computers in a distributed manner and in which the network load increases and a bottleneck is formed when shared data are concentrated in a single computer.

### DOCUMENTS OF RELATED ART

(Patent Document 1) Korean Patent Application Publication No. 10-2016-0068633, published on Jun. 15, 2016 and titled “Multiprocessor communication system sharing physical memory and communication method thereof”.

### SUMMARY OF THE INVENTION

An object of the present invention is to solve the problem in which the number of memory accesses increases exponentially when shared data are distributed across the memory of respective computers.

Another object of the present invention is to solve the problem in which, when shared data are stored intensively in a single computer, a bottleneck is formed in the CPU of the corresponding computer and the network load thereof increases.

In order to accomplish the above objects, an apparatus for sharing memory between computers according to the present invention includes multiple memory adapters, installed in corresponding ones of multiple computers, for receiving an address corresponding to an instruction from the computers and transforming the received address into an instruction in a form of a packet; and shared memory for transforming the instruction in the form of the packet, received from the multiple memory adapters, into an address and performing an operation corresponding to the instruction for a memory cell corresponding to the address.

Here, each of the memory adapters may include an input/output (I/O) controller for receiving the address corresponding to the instruction from the computer, a master-protocol-processing unit for transforming the received address into the instruction, an adapter-packet-processing unit for transforming the transformed instruction into the packet, and an adapter serial transceiver for transmitting the instruction in the form of the packet to the shared memory.

Here, the master-protocol-processing unit may transform read data, which are transmitted from the shared memory and received by the adapter serial transceiver, into a form suitable for the I/O controller and deliver the transformed read data to the I/O controller.

Here, the I/O controller may transmit the transformed read data to an input/output (I/O) slot of the computer.

Here, the shared memory may include a shared memory interface for receiving the instruction in the form of the packet from the adapter serial transceiver and performing the operation corresponding to the instruction in the form of the packet, and a physical memory array including multiple memory cells, wherein the shared memory interface may perform the operation corresponding to the instruction in the form of the packet by accessing the physical memory array.

Here, the shared memory interface may include a memory serial transceiver for communicating with the adapter serial transceiver; a memory-packet-processing unit for processing the instruction in the form of the packet, which is received by the memory serial transceiver; a slave-protocol-processing unit for transforming the processed instruction into an address; and a crossbar switch for performing the operation corresponding to the instruction for the memory cell corresponding to the transformed address.

Here, when the instruction in the form of the packet corresponds to a read instruction, the shared memory may create read data by reading data from the memory cell corresponding to an address at which data are to be read, transform the read data into a packet, and transmit the read data in the form of the packet to the memory adapter.

Here, the shared memory may transmit the read data to the memory adapter installed in the computer that transmits the corresponding instruction.

Here, the shared memory may perform packet communication with the one or more memory adapters.

Here, each of the computers may access all memory cells of the shared memory.

Also, a method for sharing memory between computers, performed by an apparatus for sharing memory between computers, which includes shared memory and multiple memory adapters, each of which is installed in an input/output (I/O) slot of a corresponding one of multiple computers, according to an embodiment of the present invention includes receiving, by each of the multiple memory adapters, an address corresponding to an instruction from the I/O slot of the computer; transforming, by the memory adapter, the received address into an instruction in a form of a packet and transmitting, by the memory adapter, the instruction in the form of the packet to the shared memory; transforming, by the shared memory, the instruction in the form of the packet, received from the memory adapter, into an address; and performing, by the shared memory, an operation corresponding to the instruction for a memory cell corresponding to the address.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that schematically shows an environment in which an apparatus for sharing memory between computers according to an embodiment of the present invention is applied;

FIG. 2 is a block diagram that shows the configuration of an apparatus for sharing memory between computers according to an embodiment of the present invention;

FIG. 3 is a block diagram that shows the configuration of a memory adapter according to an embodiment of the present invention;

FIG. 4 is a block diagram that shows the configuration of shared memory according to an embodiment of the present invention; and

FIG. 5 is a flowchart for explaining a method for sharing memory between computers performed by an apparatus for sharing memory between computers according to an embodiment of the present invention.

### DESCRIPTION OF THE PREFERRED EMBODIMENTS

Because the present invention may be variously changed and may have various embodiments, specific embodiments will be described in detail below with reference to the attached drawings.

However, it should be understood that those embodiments are not intended to limit the present invention to specific disclosure forms and that they include all changes, equivalents or modifications included in the spirit and scope of the present invention.

The terms used in the present specification are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here including technical or scientific terms have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

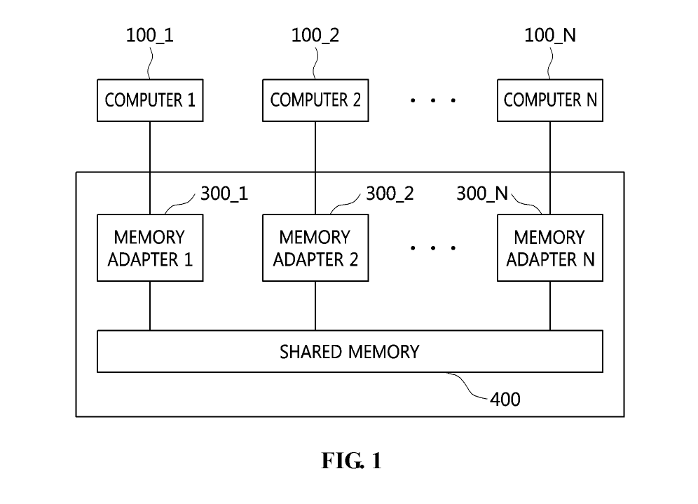

FIG. 1 is a view that schematically shows an environment in which an apparatus for sharing memory between computers according to an embodiment of the present invention is applied.

As illustrated in FIG. 1, a system for sharing memory between computers includes multiple computers 100, multiple memory adapters 300, and a shared memory 400.

The apparatus for sharing memory between computers contains the shared memory 400, including actual physical memory, instead of a conventional network switch. The respective computers 100 access the shared memory 400 using the memory adapters 300, rather than using network interface cards.

Each of the computers 100 includes a Central Processing Unit (CPU), memory, and an input/output (I/O) slot. The first computer 100_1 uses the shared memory 400 in order to send and receive data to and from another computer, thereby preventing a bottleneck.

Each of the computers 100 may access the entire area of the shared memory 400, and may exchange data by reading and writing the data from and to the shared memory 400. Also, because each of the computers 100 operates as if it had the entire shared memory 400 when it accesses the shared memory 400, the computer 100 may access the shared memory 400 in a manner similar to the method used when it accesses its main memory.

Each of the multiple memory adapters 300 may be implemented so as to be installed in the I/O slot of a corresponding one of the multiple computers 100. The computers 100 may access the shared memory 400 through the memory adapters 300 and access the physical memory array of the shared memory 400 through the shared memory interface of the shared memory 400.

For the convenience of description, the first memory adapter 300_1 and the second memory adapter 300_2 are illustrated as being installed in the first computer 100_1 and the second computer 100_2, respectively, but the first memory adapter 300_1 and the second memory adapter 300_2 may perform the same function.

The shared memory 400 receives instructions in the form of packets from the multiple adapters 300, transforms each of the instructions into an address, performs an operation corresponding to the instruction for the memory cell corresponding to the address, and transmits the result of the operation to the corresponding memory adapter 300.

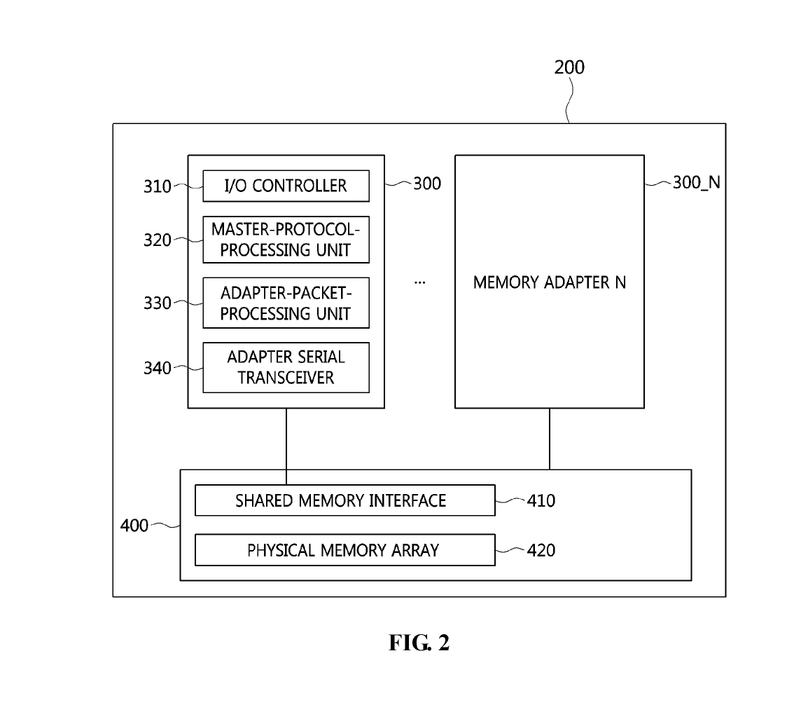

Hereinafter, the configuration of an apparatus for sharing memory between computers according to an embodiment of the present invention will be described in more detail with reference to FIGS. 2 to 4.

FIG. 2 is a block diagram that shows the configuration of an apparatus for sharing memory between computers according to an embodiment of the present invention.

As illustrated in FIG. 2, the apparatus 200 for sharing memory between computers includes one or more memory adapters 300 and a shared memory 400. The memory adapter 300 includes an input/output (I/O) controller 310, a master-protocol-processing unit 320, an adapter-packet-processing unit 330 and an adapter serial transceiver 340. The shared memory 400 includes a shared memory interface 410 and a physical memory array 420.

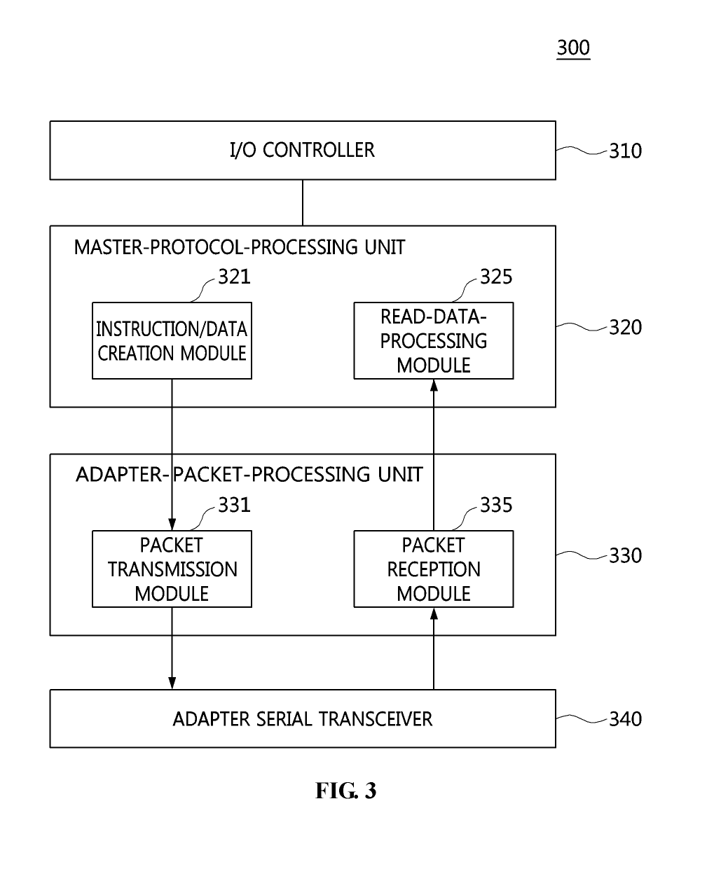

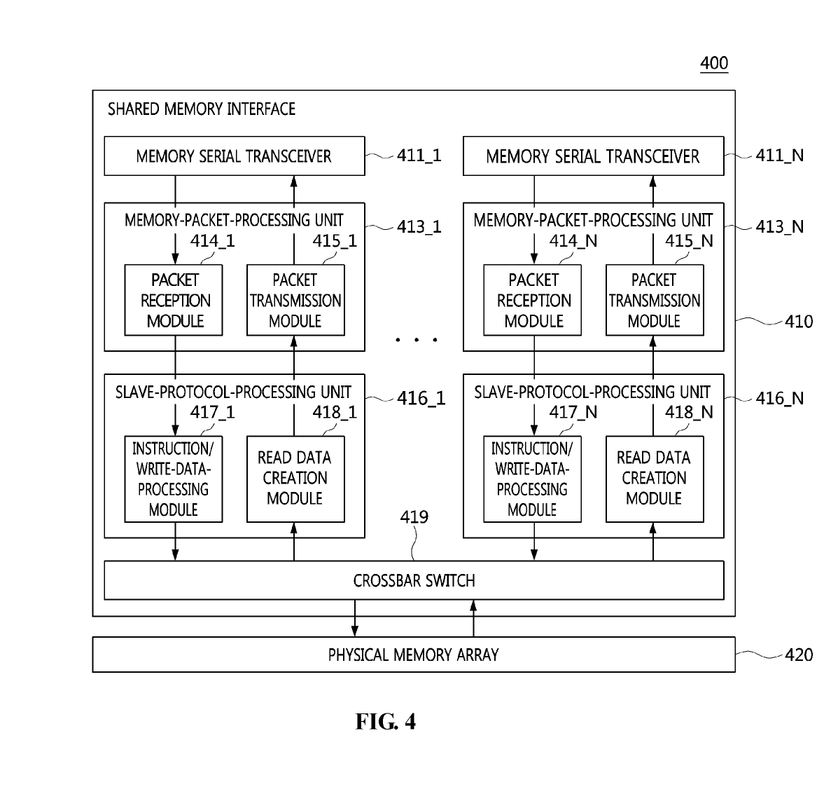

The components of the memory adapter 300 will be described in detail with reference to FIG. 3, and the components of the shared memory 400 will be described in detail with reference to FIG. 4.

In FIG. 2, the serial transceiver 340 is illustrated as being included only in the memory adapter 300 for the convenience of description, but the serial transceiver for the shared memory 400 may be included in the shared memory interface 410. Here, the adapter serial transceiver 340 and the memory serial transceiver correspond to each other in a one-to-one manner.

A description of the adapter serial transceiver 340 included in the memory adapter 300 and a description of the memory serial transceiver included in the shared memory 400 will be made with reference to FIG. 3 and FIG. 4.

FIG. 3 is a block diagram that shows the configuration of a memory adapter according to an embodiment of the present invention.

The I/O controller 310 of a memory adapter 300 communicates with a computer equipped with the memory adapter 300. The I/O controller 310 may receive an address corresponding to an instruction from the computer and transmit read data to the computer.

The master-protocol-processing unit 320 transforms a received address to an instruction or processes read data. Also, the master-protocol-processing unit 320 may match a read address with read data and perform management and monitoring functions. As illustrated in FIG. 3, the master-protocol-processing unit 320 may include an instruction/data creation module 321 and a read-data-processing module 325.

The adapter-packet-processing unit 330 may transform an instruction into a packet and transmit the packet to the shared memory 400 through the adapter serial transceiver 340. Here, the adapter serial transceiver 340 and the memory serial transceiver, included in the shared memory 400, correspond to each other in a one-to-one manner.

Also, the adapter-packet-processing unit 330 may receive read data from the shared memory 400 through the adapter serial transceiver 340 and deliver the same to the master-protocol-processing unit 320. In addition to packet transmission and reception, the adapter-packet-processing unit 330 may function to manage and monitor the adapter serial transceiver, to verify data integrity, and to control data flow.

The adapter-packet-processing unit 330 may include a packet transmission module 331 and a packet reception module 335, as shown in FIG. 3.

FIG. 4 is a block diagram that shows the configuration of shared memory according to an embodiment of the present invention.

As illustrated in FIG. 4, the shared memory 400 includes a shared memory interface 410 and a physical memory array 420. The shared memory interface 410 includes one or more memory serial transceivers 411, one or more memory-packet-processing units 413, a slave-protocol-processing unit 416, and a crossbar switch 419.

The memory serial transceiver 411 communicates with the adapter serial transceiver 340, and the memory-packet-processing unit 413 processes an instruction in the form of a packet, which is received by the memory serial transceiver 411. The slave-protocol-processing unit 416 transforms the processed instruction into an address, and the crossbar switch 419 performs an operation corresponding to the instruction for the memory cell corresponding to the address.

The memory-packet-processing unit 413 may include a packet reception module 414 and a packet transmission module 415, and the slave-protocol-processing unit 416 may include an instruction/write-data-processing module 417 and a read data creation module 418.

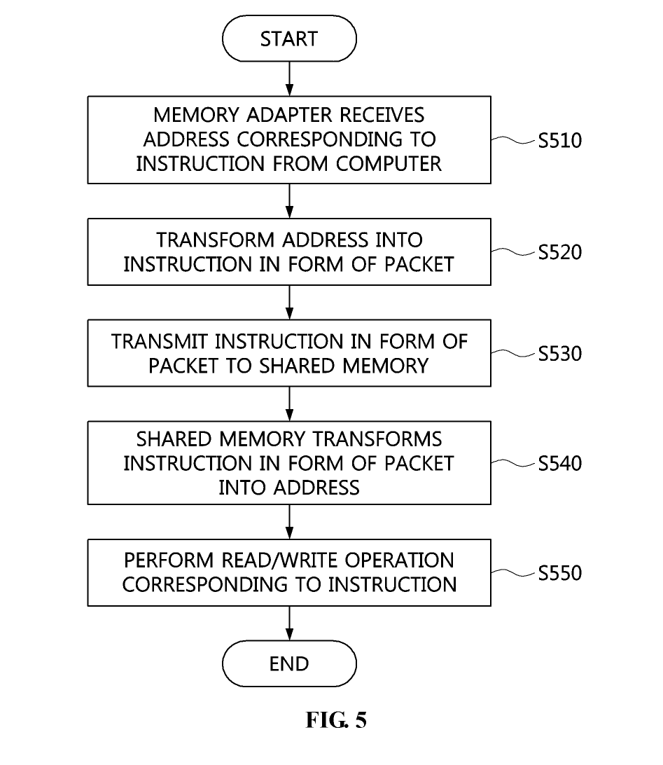

Hereinafter, a method for sharing memory between computers, performed by an apparatus for sharing memory between computers according to an embodiment of the present invention, will be described in detail with reference to FIG. 5.

FIG. 5 is a flowchart for explaining a method for sharing memory between computers, performed by an apparatus for sharing memory between computers according to an embodiment of the present invention.

First, the memory adapter 300 of the apparatus 200 for sharing memory between computers receives an address corresponding to an instruction from a computer 100 at step S510.

The memory adapter 300 receives an address corresponding to a write instruction or a read instruction from the I/O slot of the computer 100. Here, the memory adapter 300 may receive data to be written and a write address at which the data are to be written in the case of a write instruction, or may receive a read address at which data are to be read in the case of a read instruction.

Then, the memory adapter 300 of the apparatus 200 for sharing memory between computers transforms the received address into an instruction in the form of a packet at step S520, and transmits the instruction in the form of a packet to the shared memory 400 of the apparatus 200 for sharing memory between computers at step S530.

Because the memory adapter 300 and the shared memory 400 communicate with each other using packets, the memory adapter 300 transforms the read address or the write address into the instruction in the form of a packet and transmits the instruction in the form of a packet to the shared memory 400.

Then, the shared memory 400 of the apparatus 200 for sharing memory between computers transforms the instruction in the form of a packet into an address at step S540, and performs a read or write operation corresponding to the instruction at step S550.

When the instruction corresponds to a write operation, the shared memory 400 may store data in the memory cell corresponding to the write address. Conversely, when the instruction corresponds to a read operation, the shared memory 400 may read data from the memory cell corresponding to the read address and deliver the read data to the computer 100.

For example, when the computer 100 attempts to write to the shared memory 400, the CPU of the computer 100 may receive data to be written from the memory thereof or create data to be written by itself and send the data to be written and a write address at which the data are to be written to the memory adapter 300 via the I/O slot.

The memory adapter 300 receives the data to be written and the write address through the I/O controller, and the instruction/data creation module transforms the data and the write address into a write instruction and data. The transformed write instruction and data may be transformed into a packet in the packet transmission module of the memory adapter 300, and may then be transmitted in the form of a signal through the adapter serial transceiver. Here, the signal may be at least one of an optical signal, an electric signal, and a radio-wave signal.

The shared memory interface 410 of the shared memory 400 may receive the write instruction and data, which are transmitted through an optical cable, electric cable, wire, or air medium, using the memory serial transceiver. After they pass through the packet reception module, the received write instruction and data are transformed back into the write address and the data to be written in the instruction/write-data-processing module of the slave-protocol-processing unit, and the write address and the data to be written are delivered to a specific memory cell in the physical memory array 420 via the crossbar switch.

Also, when the computer 100 attempts to read from the shared memory, the CPU of the computer 100 creates a read address and delivers the created read address to the memory adapter 300 via the I/O slot.

The I/O controller of the memory adapter 300 receives the read address and transmits the received read address to the instruction/data creation module of the master-protocol-processing unit. The instruction/data creation module transforms the read address into a read instruction, and the packet transmission module transforms the read instruction into a packet and transmits the packet to the shared memory 400 through the adapter serial transceiver.

Here, the adapter serial transceiver may transmit the packet in the form of a signal, in which case the signal may be at least one of an optical signal, an electric signal, and a radio-wave signal. The packet transmitted in the form of a signal may be delivered to the shared memory interface of the shared memory 400 through at least one of an optical cable, electric cable, wire, and air medium.

The memory serial transceiver receives the read instruction and transmits the same to the instruction/write-data-processing module of the slave-protocol-processing unit via the packet reception module, and the instruction/write-data-processing module transforms the read instruction into an address and delivers the address to the crossbar switch.

The read instruction transformed into an address is delivered to the memory cell at the address corresponding to the read instruction in the physical memory array. Then, read data are created by reading from the physical memory array and delivered to the read data creation module of the slave-protocol-processing unit via the crossbar switch. The read data transformed into a form suitable for packet transmission in the read data creation module are again transformed into a packet in the packet transmission module, and are delivered to the memory adapter via the memory serial transceiver.

The read data received by the memory adapter pass through the packet reception module and are then transformed into a form suitable for the I/O controller in the read-data-processing module. Then, the read data are delivered to the CPU of the computer 100 via the I/O slot of the computer 100. Also, the CPU may store the received read data in the memory of the computer 100, or may itself use the read data.

As described above, because the memory adapter 300 of the apparatus for sharing memory between computers according to an embodiment of the present invention may access all memory areas of the shared memory 400, each of the first to N-th computers may access the shared memory 400 as if it had the entire area of the shared memory. Also, when they access the shared memory 400, the first to N-th computers may use the physical memory array of the shared memory 400 in the same manner as the method of accessing the main memory thereof.

Also, according to the apparatus for sharing memory between computers according to an embodiment of the present invention, the number of memory accesses linearly increases such that excessive access to the memory resources in the computer is prevented, and a bottleneck may be avoided when the CPU of the computer processes data.

According to the present invention, it is possible to solve the problem in which the number of memory accesses increases exponentially when shared data are distributed across the memory of respective computers.

Also, according to the present invention, the number of data exchanges caused when data shared between multiple computers are distributed in the memory of the respective computers may be sharply decreased so as to change linearly with the number of computers.

Also, according to the present invention, it is possible to solve the problem in which, when shared data are stored intensively in a single computer, a bottleneck is formed in the CPU of the corresponding computer and the network load thereof increases.

Also, according to the present invention, a bottleneck that may be caused because the CPU of the computer storing shared data is solely responsible for the supply of the data may be eliminated.

As described above, the apparatus and method for sharing memory between computers according to the present invention are not limitedly applied to the configurations and operations of the above-described embodiments, but all or some of the embodiments may be selectively combined and configured, so that the embodiments may be modified in various ways.

What is claimed is:

1. An apparatus for sharing memory between computers, comprising:
multiple memory adapters, installed in corresponding ones of multiple computers, for receiving an address corresponding to an instruction from the computers and transforming the received address into an instruction in a form of a packet; and
shared memory for transforming the instruction in the form of the packet, received from the multiple memory adapters, into an address and performing an operation corresponding to the instruction for a memory cell corresponding to the address.

2. The apparatus of claim 1, wherein each of the memory adapters comprises
an input/output (I/O) controller for receiving the address corresponding to the instruction from the computer,
a master-protocol-processing unit for transforming the received address into the instruction,
an adapter-packet-processing unit for transforming the transformed instruction into the packet, and
an adapter serial transceiver for transmitting the instruction in the form of the packet to the shared memory.

3. The apparatus of claim 2, wherein the master-protocol-processing unit transforms read data, which are transmitted from the shared memory and received by the adapter serial transceiver, into a form suitable for the I/O controller and delivers the transformed read data to the I/O controller.

4. The apparatus of claim 3, wherein the I/O controller transmits the transformed read data to an input/output (I/O) slot of the computer.

5. The apparatus of claim 2, wherein the shared memory comprises
a shared memory interface for receiving the instruction in the form of the packet from the adapter serial transceiver and performing the operation corresponding to the instruction in the form of the packet, and
a physical memory array including multiple memory cells,
wherein the shared memory interface performs the operation corresponding to the instruction in the form of the packet by accessing the physical memory array.

6. The apparatus of claim 5, wherein the shared memory interface comprises
a memory serial transceiver for communicating with the adapter serial transceiver,
a memory-packet-processing unit for processing the instruction in the form of the packet, which is received by the memory serial transceiver,
a slave-protocol-processing unit for transforming the processed instruction into an address, and
a crossbar switch for performing the operation corresponding to the instruction for the memory cell corresponding to the transformed address.

7. The apparatus of claim 1, wherein, when the instruction in the form of the packet corresponds to a read instruction, the shared memory creates read data by reading data from the memory cell corresponding to an address at which data are to be read, transforms the read data into a packet, and transmits the read data in the form of the packet to the memory adapter.

8. The apparatus of claim 7, wherein the shared memory transmits the read data to the memory adapter installed in the computer that transmits the corresponding instruction.

9. The apparatus of claim 1, wherein the shared memory performs packet communication with the one or more memory adapters.

10. The apparatus of claim 1, wherein each of the computers is capable of accessing all memory cells of the shared memory.

11. A method for sharing memory between computers, performed by an apparatus for sharing memory between computers, which includes shared memory and multiple memory adapters, each of which is installed in an input/output (I/O) slot of a corresponding one of multiple computers, the method comprising:
receiving, by each of the multiple memory adapters, an address corresponding to an instruction from the I/O slot of the computer;
transforming, by the memory adapter, the received address into an instruction in a form of a packet and transmitting, by the memory adapter, the instruction in the form of the packet to the shared memory;
transforming, by the shared memory, the instruction in the form of the packet, received from the memory adapter, into an address; and
performing, by the shared memory, an operation corresponding to the instruction for a memory cell corresponding to the address.
